(19) United States
(12) Patent Application Publication
(10) Pub. No.: US 2004/0148631 A1
(43) Pub. Date: Jul. 29, 2004

(54) Method of automatic control of operation of digital television decoder

(75) Inventor: Czeslaw Zubowicz, Zielona Gora (PL)

Correspondence Address: HOFFMANN & BARON, LLP, 6900 JERICHO TURNPIKE, SYOSSET, NY, 11791, US

(73) Assignees: Advanced Digital Broadcast Polska Sp. z o.o; Advanced Digital Broadcast Ltd.

(21) Appl. No.: 10/759,574

(22) Filed: Jan. 16, 2004

(30) Foreign Application Priority Data
Jan. 20, 2003 (PL) P-358355

(51) Int. Cl. H04N 7/16; G06F 13/00; H04N 5/445; G06F 3/00; H04N 5/44

(52) U.S. Cl. 725/53; 348/553; 725/135; 725/46; 725/45

(57) ABSTRACT

A method of automatic control of a digital television decoder operation uses an Electronic Program Guide system. When a program, from a control list created earlier by a user by selecting specific programs, starts, a decoder changes its operation mode from a sleep mode to an active mode. In the active mode the user can watch only the programs located on the list, and after the program from the list ends, and in case there are no other available programs on the list, the decoder changes its operation mode to the sleep mode. At each time when a new program from the list starts, the decoder generates an information signal. In the described solution there are available many lists controlling the operation of the decoder. The lists are created by the user or set by an operator, and the user chooses which of the lists should control the operation of the decoder.

### CROSS-REFERENCE TO RELATED APPLICATIONS

This application claims priority to Polish Application No. P-358355, filed Jan. 20, 2003, the contents of which are incorporated herein by reference.

### BACKGROUND OF THE INVENTION

1. Field of the Invention

The present invention relates to a method of automatic control of operation of digital television decoder using an Electronic Program Guide (EPG) application.

2. Brief Description of the Background of the Invention Including Prior Art

There are known and commonly applied systems for controlling television receiver operation, called parental control systems, which allow preventing any unauthorized use of a TV receiver by children. Such a system is known, for example, from the U.S. Pat. No. 6,072,520 to Yuen et al. This is a typical system, which has a function of blocking or making specific channels or programs available. In a specific embodiment the means for blocking comprise means for decoding and expanding a compressed code, representative of, and compressed in length from, the combination of a channel, a date, a time-of-day, and a length for a program.

Another similar system is known from the European Patent Application No. EP 1 134 972 A2 to Kahn. In comparison to typical systems of parental control, this system has additionally the function of setting a time limit (for example daily limit) to watch television. A controller of this system controls a video processor based on the use of the TV receiver in response to command signals sent by the user and predetermined criteria set by a system administrator.

The described systems are mainly used for blocking the TV receiver in specific time.

### SUMMARY OF THE INVENTION

### Purposes of the Invention

It is an object of this invention to provide a method of automatic control of operation of digital television decoder (also called a set-top box or an integrated receiver decoder) using an Electronic Program Guide (EPG) application improving known parental control systems of television use.

This and other objects and advantages of the present invention will become apparent from the detailed description, which follows.

### Brief Description of the Invention

The present invention provides a method of automatic control of a digital television decoder operation. When a program (from a control list, created earlier by a user by selecting specific programs) starts, a decoder changes its operation mode from a sleep mode to an active mode. In the active mode the user can watch only the programs located on the list, and after the program from the list ends, and in case there are no other available programs recorded on the list, the decoder changes its operation mode to the sleep mode. At each time when a new program from the list starts, the decoder generates an information signal. In the described embodiment there are available many lists controlling the operation of the decoder. The lists are created by the user or set by an operator, and the user chooses which list should control the operation of the decoder. The lists can be associated with a specific topic. The lists, set by the operator can be subject lists or can be associated with names of well-known people, creating so-called preferential lists. Moreover, each time a new program from the list starts, the decoder plays audio information in the form of a specific sound or a verbal announcement.

The novel features, which are considered as characteristic for the invention are set forth in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

In the accompanying drawings one of the possible embodiments of the present invention is shown, where

FIG. 1 is a block diagram of a TV receiver;

FIG. 2 is a view of a screen after using a function for creating or modifying program lists;

FIG. 3 is a flow chart of an algorithm for servicing functions on lists available to a user;

FIG. 4 is a flow chart of a procedure for modifying a selected list;

FIG. 5 is a flow chart of an algorithm for adding new programs to a list;

FIG. 6 is an exemplary content of a list;

FIG. 7 is a flow chart of a system activation function;

FIG. 8 is a flow chart of a system deactivation function;

FIG. 9 is a flow chart of a function for changing an access code;

FIGS. 10A and 10B show a flow chart of an adding function; and

FIG. 11 shows examples of screen views.

### DESCRIPTION OF INVENTION AND PREFERRED EMBODIMENT

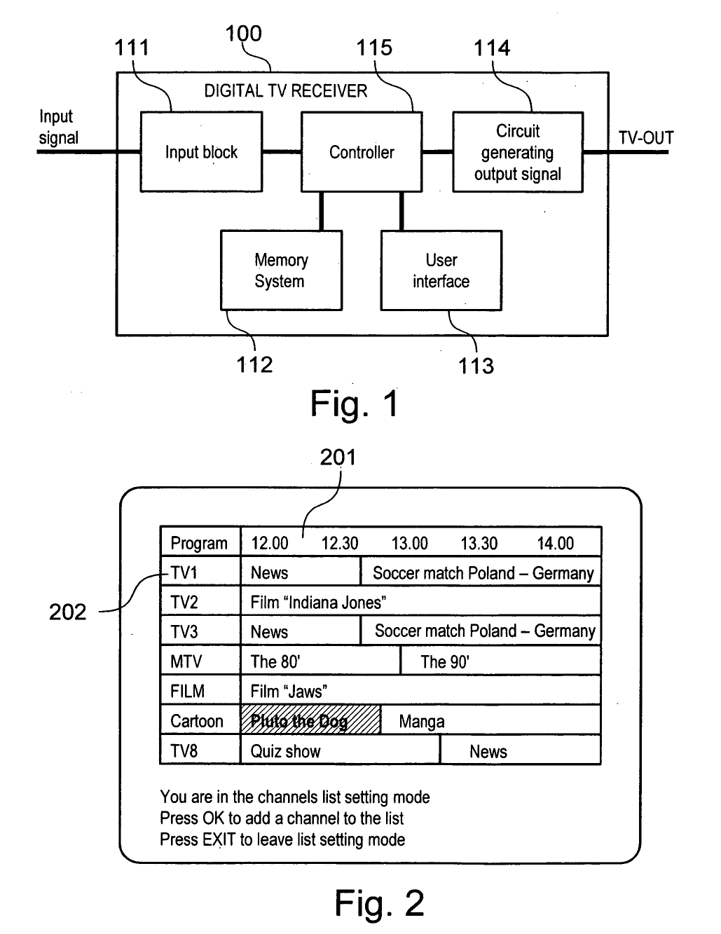

The system described below is designed for application in digital television decoders. A block diagram of such decoder is shown in FIG. 1. The decoder 100 has an input block 111, which is responsible for receiving a cable satellite or terrestrial television signal and for transforming it into a digital data stream, for example, an MPEG stream. The digital signal can be descrambled by a conditional access system. Further the decoder has a memory system 112 consisting of various memory types, such as RAM, ROM, EEPROM, Flash, HDD. The decoder has also a user interface 113, which allows the user to send commands controlling the decoder. A typical example is a Remote Control Unit (RCU). Moreover, the decoder has an image processing system 114. This system contains audio and video decoders, for example AC/3 and MPEG decoders, and also systems generating additional signals, for example an on-screen display (OSD) system and systems converting digital signal into a format of the TV set, for example PAL, SECAM, NTSC. Additionally the decoder has a controller 115 or a module for control of operation of other systems and data transfer between them. This function can be realized by a specialized processor. The presented blocks are only functional blocks and are not meant to represent separate electronic elements.

The operation of the above-described decoder may be controlled by a user application, which allows to select which programs may be watched. The application, by displaying appropriate information by means of the OSD system, allows the user to select appropriate functions. Based on them, the application can control other functions, for example activating the decoder, tuning to a requested channel, decoding the requested program, interaction with an Electronic Program Guide (EPG) application.

A typical EPG application displays the contents of selected channels usually in the form of a grid, shown in FIG. 2, where the x axis 201 is the time axis, and the y axis 202 is the axis of TV channel names. Each field of the table contains the title of the program broadcasted at a given time on a given channel. The decoder can operate in a normal mode or in a list mode. If the decoder operates in the normal mode, all functions, which enable interacting with the lists, are available from appropriate menu. Functions, which modify the settings of the lists, are not available in the list mode. The described system adds to the EPG application an additional function, which allows creating lists of programs, which can be watched. This can be done by specifying selected programs, time intervals or program types, which are to be available to the user. An exemplary view of the screen during the operation of this function is shown in FIG. 2, where the user has selected a list mode for setting a program list. By selecting specific fields, after pressing the <OK> button, the given program will be added to the list.

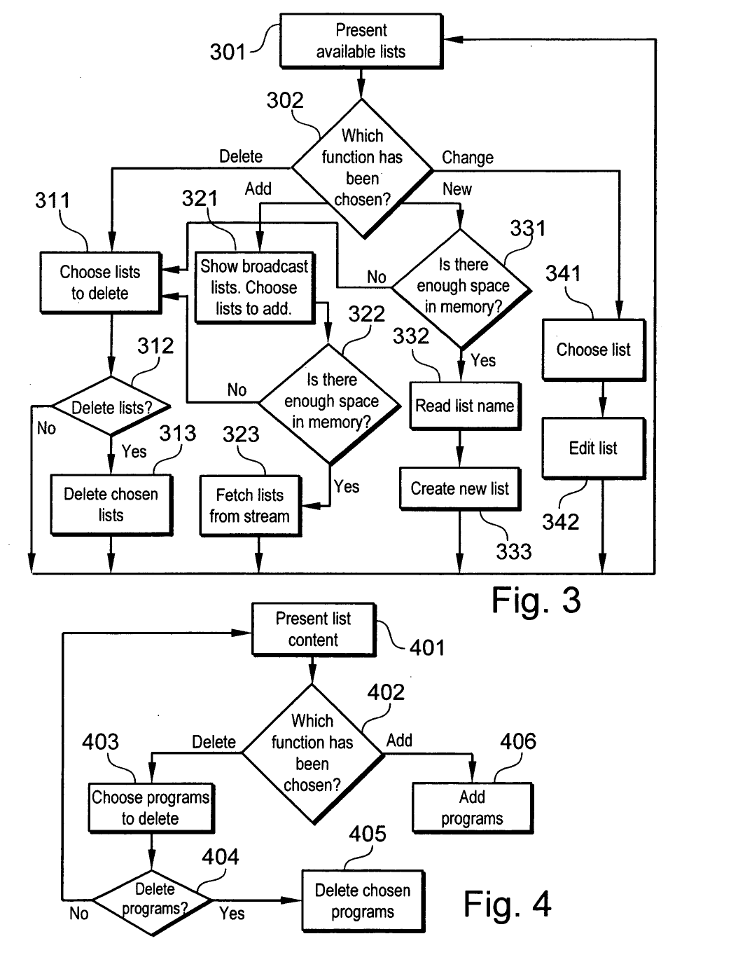

In turn, FIGS. 3, 4 and 5 show the algorithm of creating and updating a program list. The decoder operation can be controlled by one of many lists selected by the user. These lists can be created by the user or the operator or can be the operator's lists modified by the user. Therefore a list of available program lists is stored in the decoder. The program lists, which are set by the operator are added to it automatically. An exemplary list of available lists can contain the following items:

1. Dad_Sport

2. Dad_News

3. Mum_Music

4. Ann_Cartoons

5. _Mr.X_Recommends

6. _Mr.Y_Recommends

7. _Music_the 60's

Items 1-4 are the lists set by the users, and they refer to selected sport programs, news, music programs and cartoons for children. Items 5-7 are the lists broadcasted by the operator, to make the choice easier for the user. For example, it can be a list containing programs related to music of the 1960's—the operator will create it, based on the program content of various channels. The operator can also broadcast lists, which are arranged by people well-known from public life, for example by well-known actors, politicians, singers, etc. Then, the decoder operation will be controlled on the basis of the choice made by a specific person, for example a famous actor. The lists can be stored in the memory of the decoder in a form of files, where the name of the list would constitute the file name, which makes easy to find it. The decoder allocates a certain memory amount for the lists, the size of which can be adjusted by the user. The lists can be broadcasted by the operator in the television signal. When new lists appear, the user can choose which lists, out of the ones located in the memory, should be deleted and the lists which should be recorded in their place. Similarly, when new lists are being created, if there is no space in memory, the user can select which list should be overwritten by the newly created list.

After the user requests the list editing function, a list of available program lists is presented to the user in step 301. Next, in step 302, the user can delete, add, create or change the existing program list. If the user wants to delete program lists, ones which are to be deleted are selected in step 311. Next, when the choice is confirmed in step 312, the lists or files are removed from the memory in step 313. If the user wants to add program lists broadcasted by the operator, the procedure displays a list of lists broadcasted in the television signal in step 321. The user selects the lists, which are to be stored locally in the decoder. The procedure checks in step 322 if there is sufficient memory space for recording the selected lists. If there is not, it moves to the list deletion menu in step 311. If there is sufficient memory space, it collects the selected lists from the television data stream and stores them locally as files in step 323. If the user wants to create a new list, the procedure in step 331 checks if there is enough memory space. If there is space, the user inputs the list name, and next it is created in the memory in steps 332 and 333. If the user wants to modify the list, they are selected in step 341 and edited in step 342.

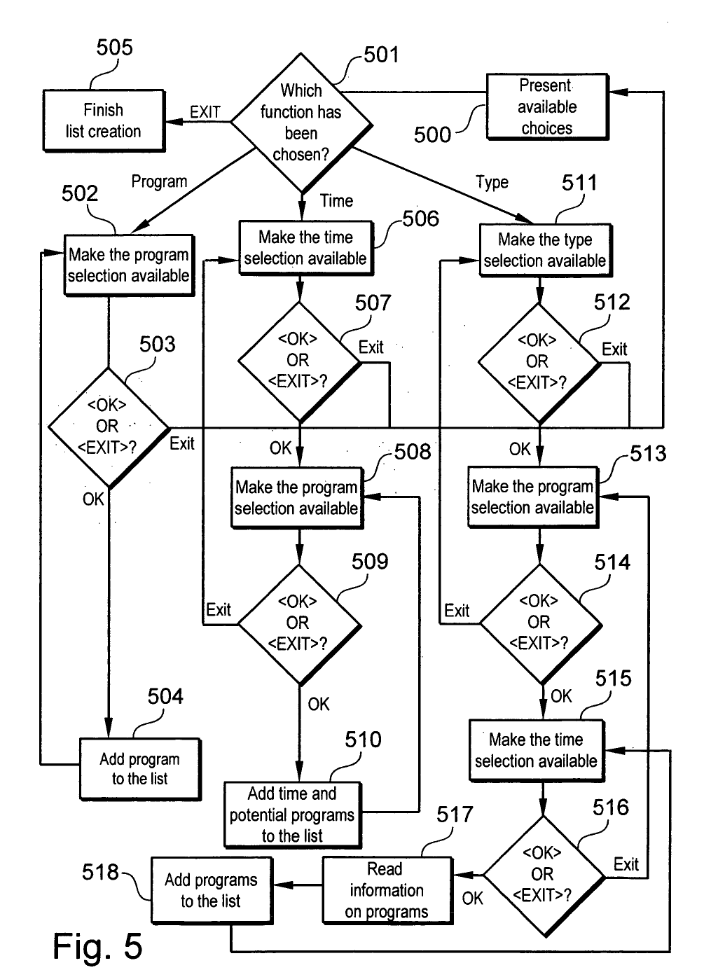

The procedure for modifying the selected list, shown in FIG. 4, starts in step 401. The contents of the list (programs, which are included in it) are displayed on the screen. In step 402 the user can remove items (programs) from the list or add new items. To delete the programs, the user selects the programs to be deleted in step 403, and next, after confirmation in step 404, they are deleted in step 405. To add new programs, a procedure shown in FIG. 5 is executed.

FIG. 5 illustrates an algorithm for adding new programs to the list. The user can start to create the list in step 501 by selecting specific programs or selecting the time, in which the decoder is to be active or selecting the type of programs, which are to be watched. If the user chooses selecting specific programs, in step 502, the EPG application allows the user to select programs from an EPG table. When the user selects an appropriate program and confirms it by pressing the <OK> button in step 503, the application reads the information about the program (channel name, program name, broadcasting time), and adds it to the list in step 504. When the <EXIT> button is pressed in step 503, the user can choose further programs after available choices are presented in step 500 or finish selection in step 505. If the user chooses to select the time, in which the decoder is to be active, the EPG application will make it possible for the user to choose the time, in step 506, which may be confirmed by pressing the <OK> button in step 507. Next, the user can choose the channels, which can be watched in a predefined time ( all channels may be selected as well) in step 508. In the next step 510, after confirmation by pressing the <OK> button in step 509, the specific time interval, with possible restriction of programs, will be added to the list. The user can continue the selection of other time intervals. If the user chooses to select a program type to be watched, the EPG application enables to choose the program types in step 511. After the user selects a specific type and confirms it by pressing the <OK> button in step 512, the user may select the channel, on which the given programs type should be watched in step 513. All channels may be selected as well. After confirming by pressing the <OK> button in step 514, in the next step 515 the user may define the time, in which the application should find the specific type of programs. After the user confirms the choice in step 516, the application reads which programs meet the specific criteria in step 517. If it finds such programs, it adds them to the list in step 518. Next, the user can choose another type of programs. The program lists are stored in the memory of the decoder. They can be stored in Flash memory, on a hard disk or in any other type of permanent memory.

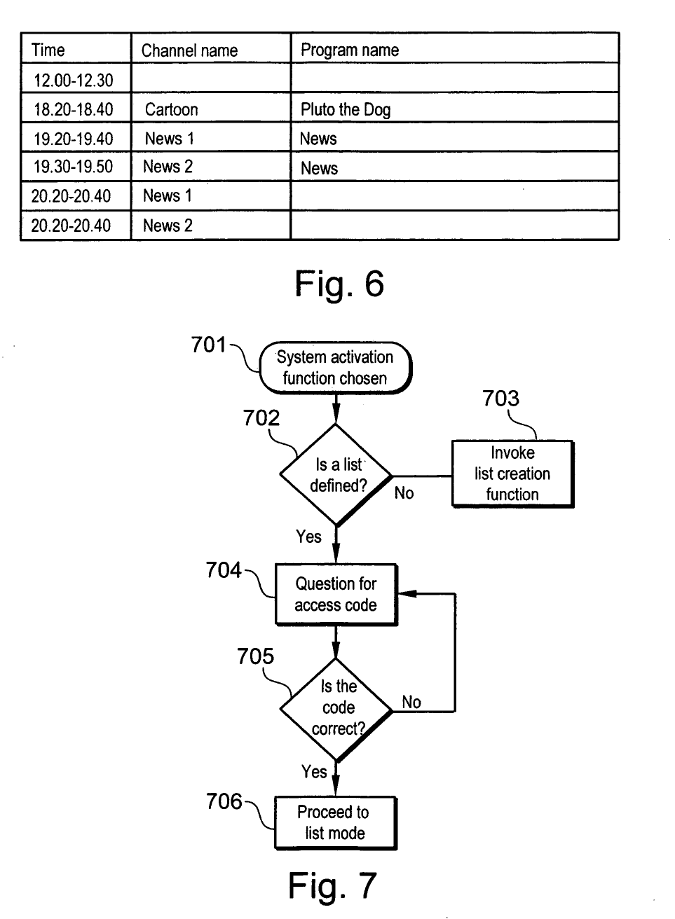

The format of the list and its exemplary content is illustrated in FIG. 6. This list allows the user to receive the following programs:

between 12.00 and 12.30—any program on any channel;

between 18.20 and 18.40—‘Pluto the Dog’ on channel ‘Cartoon’;

between 19.20 and 19.40—‘News’ on channel ‘News1’;

between 19.30 and 19.50—‘News’ on channel ‘News2’;

between 20.20 and 20.40—any program on channels ‘News1’ and ‘News2’.

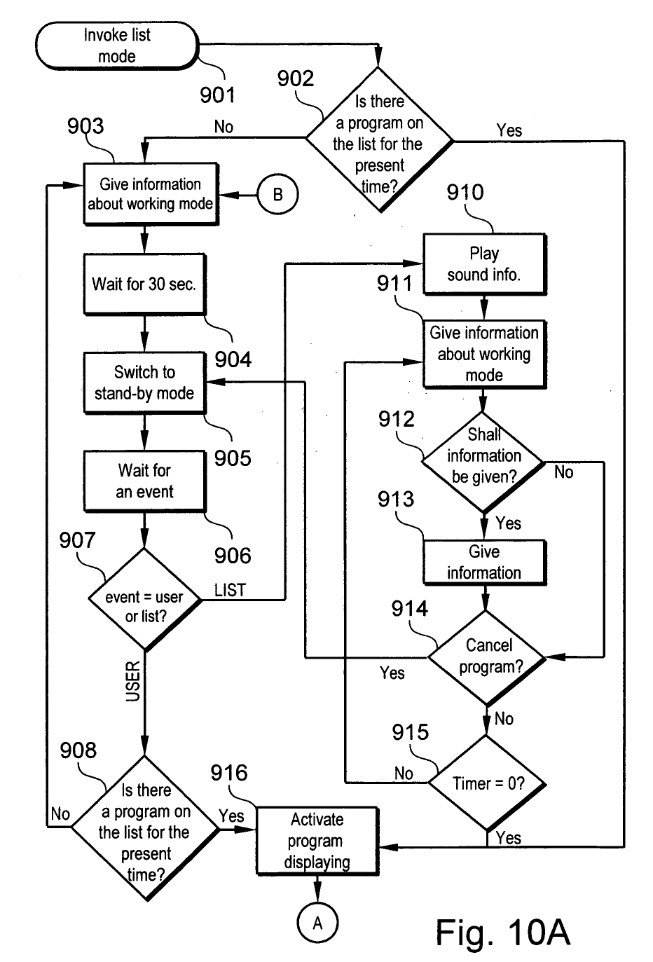

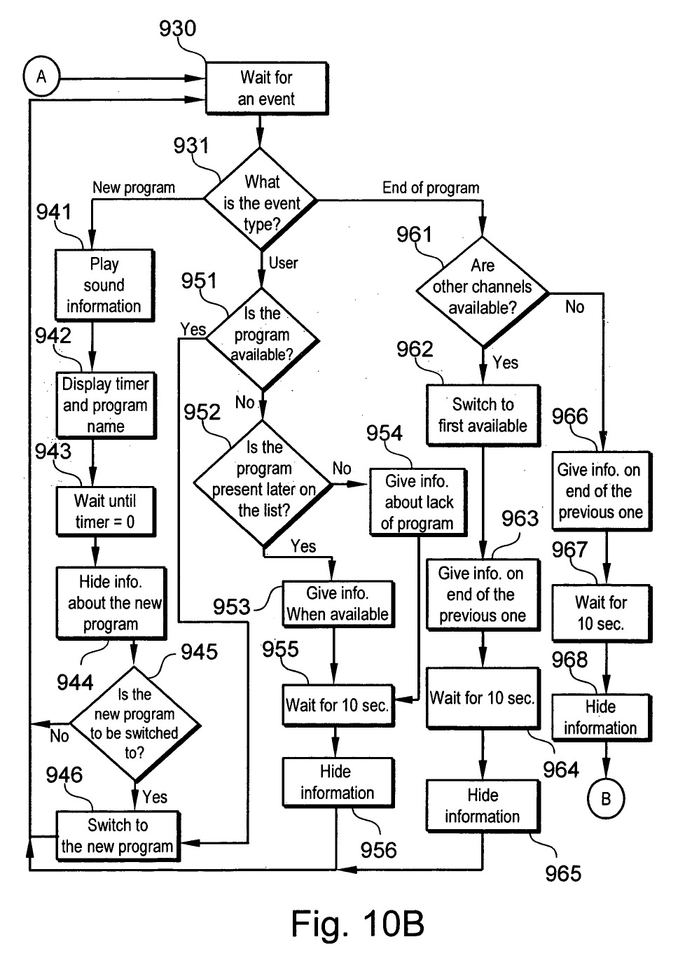

FIG. 7 shows the function of system activation. After start in step 701, the function checks in step 702, if a list was defined. If not—it moves in step 703 to the function of list creation, shown in FIG. 3. If the list is already defined, the function asks for access code in step 704. This is to protect the system against activation by an unauthorized person. Such activation would make it impossible to return to normal operation. After the correct code is entered in step 705, the system moves to the list editing mode in step 706, shown in FIGS. 10A and 10B.

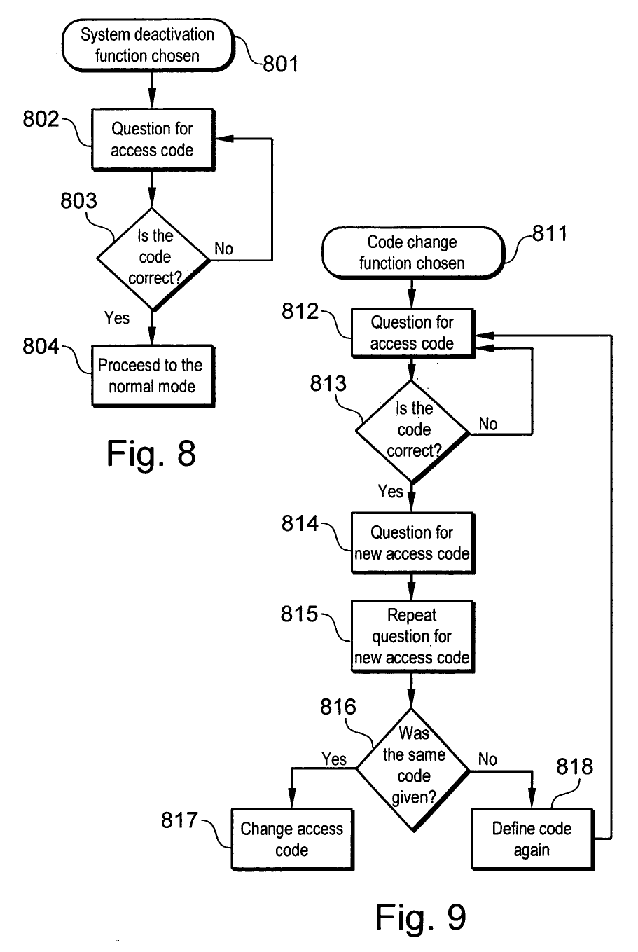

FIG. 8 shows the function of system deactivation. The function starts in step 801 and asks for the access code in step 802. In step 803 it is checked if the correct code is entered. In step 804 the system shifts to normal operation, which enables to watch all the programs or returns to step 802.

FIG. 9 shows an exemplary algorithm of changing the access code. The function starts in step 811 and asks for the previous access code in step 812. In step 813 it is checked if the correct code is given. After the user provides the correct access code, the function asks twice for the new access code in step 814 and in step 815. In step 816 it is checked if the same code was given twice. When both new codes are identical, the function changes the previous code into a new one in step 817. If not—it informs the user about the need to enter the code once again in step 818 and starts the procedure of changing the code.

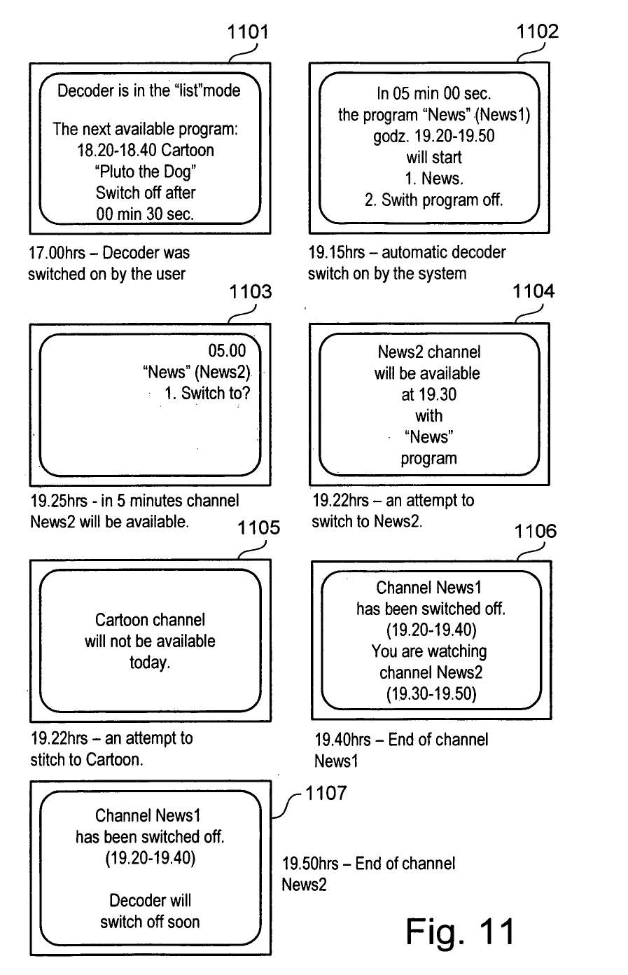

FIGS. 10A and 10B illustrate an example of system operation in the list mode and FIG. 11 shows examples of screen views at a specific hour and a specific event. When the decoder receives a command of changing to the list mode in step 901, it checks first, if there is any active program for the current time in step 902. If there is an active program, the decoder will be activated, displaying this program in step 916. If there is no active program, it displays a message in step 903, informing that it is in the list mode, providing information about the next available program and informing that the decoder will turn off in a specified time. This time is displayed as a count-down timer, where the countdown starts from a specific time—for example 30 sec. (screen 1101 shown in FIG. 11). When the time counted down by the timer elapses in step 904, the decoder shifts to the sleep mode in step 905 and waits in this mode for an event in step 906. If the event is an activation of the decoder by the user, the procedure checks if in the given time there is any program available on the list in step 908. If there is no program available, it returns to step 903. If there is a program available, the program selected by the user will be started in step 916. Another event may be the upcoming time of broadcasting a program. When the decoder detects that a program will start in a certain time (for example 5 minutes), it will play a voice message in step 910, for example: ‘In 5 minutes a program will be broadcasted’ and display a message on the mode of operation in step 911 on the screen informing that in a given time the decoder will switch to reception of a specific program, while this time is counted down by a timer, displayed on the screen. The message also informs about the possibility of reading additional information about this program, available in the EPG system. It will also make it possible to cancel watching this program (screen 1102 shown in FIG. 11). If the user decides to watch EPG information related to the given program, the procedure activates the program guide, indicating the requested program. The EPG may display the contents of the program and other information about it in step 913. If the user cancels watching this program in step 914, the procedure will return to step 905, which means that it will switch to the sleep mode. The effect will be that the decoder will be not activated in the moment, when the program starts, although the user will be able to switch it on manually. If the user does not decide to cancel watching the program, and the time counted by the timer in step 915 elapses, the decoder starts broadcasting the selected program in step 916. After tuning to the selected program in step 916, the decoder moves to point A of the procedure and waits for an event in step 930. If the event is the upcoming time of starting a broadcast of another program from the list (for example in 5 minutes), an audio message will be played. In this case, it can be a short sound, e.g. a gong in step 941 so that watching the current program is undisturbed. Next a timer, counting the time left to the beginning of a new program is displayed with short information about it—possibly in a small form, so that watching the current program is undisturbed. The user, by means of a specific button of the remote control unit can request the decoder to change to a new program, immediately when it starts (screen 1103 shown in FIG. 11). If the event is a selection of a program by the user, the procedure checks in the list if there is a program available to be watched in step 951. If there is one, the procedure tunes the decoder to the selected channel in step 946. If there is no program available, it checks if the program is available on the list in a later time in step 952. If so, it provides information, at what time the given channel will be available in step 953 (screen 1104 shown in FIG. 11). If not, it provides information that the given channel is unavailable in step 954 (screen 1105 shown in FIG. 11). Next in step 955 it waits a short while, for example 10 seconds, and it switches off the displayed information in step 956 and shifts to waiting for the next event. If the event is the end of broadcasting a program from the list, the system checks if there are other programs available on the list, broadcasted at this moment in step 961. If so, it moves to the first available channel on the list in step 962. Next it displays information on the end of broadcasting the previous program in step 963 (screen 1106 shown in FIG. 11), waits a short time (10 seconds for example) in step 964, closes the displayed information in step 965 and waits for the next event. If there are no more programs on the list, the system gives information about the end of broadcasting the previous program in step 966 (screen 1107 shown in FIG. 11), in step 967 waits a short time, for example 10 seconds, closes the displayed information in step 968 and moves to point B of the procedure.

The digital television decoder in which the presented method is implemented must be equipped with an Electronic Program Guide (EPG) system. Using this guide the user selects programs, which create a list controlling the operation of the decoder. The presented method of controlling television programs being watched allows establishing which programs and in what hours can be watched. Beyond these hours the television decoder is inactive. With the beginning of the program, which can be watched, the decoder is automatically activated, and next automatically shut down (changes to sleep mode) after the end of the program. When the decoder is active, the user can watch only the programs, which are on the list. The lists of programs can be created by the user or delivered by the operator. The user can choose the list to control the operation of the decoder. The presented system can have many applications. In the fist one it can be used by parents to control programs watched by children, which means that the parents can decide which programs at what times can be watched. In the second one it can be used by a person, watching only the specific types of programs, for example, the decoder will be activated only in case when a specific news program is broadcasted. In the third one it can be used in public places, where automatic control of the broadcasted program is needed.

The preferred embodiments having been thus described, it will now be evident to those skilled in the art that further variation thereto may be contemplated. Such variations are not to be regarded as a departure from the invention, the true scope of the invention being set forth in the claims appended hereto.

What is claimed is:

1. A method of automatic control of operation of a digital television decoder comprising
switching-on the digital television decoder;
switching the digital television decoder to an active mode when a program on the list of programs is currently available; and
switching the digital television decoder to a sleep mode when no program located on the list of programs is currently available.

2. The method of automatic control of operation of the digital television decoder according to claim 1, wherein the list of programs is created by a user.

3. The method of automatic control of operation of the digital television decoder according to claim 1, wherein the list of programs is associated with a specific topic.

4. The method of automatic control of operation of the digital television decoder according to claim 1, wherein the list of programs is created by a well-known person.

5. The method of automatic control of operation of the digital television decoder according to claim 1, wherein the list of programs is created by an operator and chosen by a user.

6. The method of automatic control of operation of the digital television decoder according to claim 5, wherein the list of programs set by the operator is subject list or associated with names of well-known people.

7. The method of automatic control of operation of the digital television decoder according to claim 1, further comprising
generating an information signal when a new program on the list of programs starts.

8. The method of automatic control of operation of the digital television decoder according to claim 7, wherein the information signal is a specific sound or a verbal announcement.

9. The method of automatic control of operation of the digital television decoder according to claim 1, wherein when the decoder is in the active mode, the user may only watch programs that are available on the list.

10. The method of automatic control of operation of the digital television decoder according to claim 1, wherein when the decoder is in the sleep mode, no program may be watched.

11. The method of automatic control of operation of the digital television decoder according to claim 10, wherein when the decoder is in the sleep mode and the user requests to watch a program, information about the next available program is displayed.

12. The method of automatic control of operation of the digital television decoder according to claim 9, wherein when the decoder is in the active mode and a new program on the list becomes available, an audio and/or a video information is generated.

13. The method of automatic control of operation of the digital television decoder according to claim 10, wherein when the decoder is in the sleep mode and a new program from the list is to be broadcasted, an information about the program is displayed in a specific time prior to the beginning of the program.

14. The method of automatic control of operation of the digital television decoder according to claim 13, wherein when the information related to a program is displayed, the user has a possibility of canceling watching the program, which results in not switching to the active mode when the program starts.
